(19) United States
(12) Patent Application Publication
(10) Pub. No.: US 2011/0040806 A1
(43) Pub. Date: Feb. 17, 2011

(54) Dynamically flexible database

(75) Inventors: Bradley K. Lee, Plano, TX (US); Amir Elmallakh, Frisco, TX (US); Keith E. Kratochvil, Frisco, TX (US)

Correspondence Address: DOCKET CLERK, P.O. DRAWER 800889, DALLAS, TX, 75380, US

(73) Assignee: CareSmart Solutions, LLC, Dallas, TX (US)

(21) Appl. No.: 12/462,944

(22) Filed: Aug. 12, 2009

(51) Int. Cl. G06F 17/30; G06F 7/00

(52) U.S. Cl. 707/809; 707/E17.005; 707/E17.009

(57) ABSTRACT

Systems and methods are disclosed that may be used for storing information in a database that has at least one table. The at least one table has at least one field. The at least one field has a data type assigned to the at least one field. In some embodiments, at least one data element is stored in at least one field. The at least one data element may have a data type which is unrelated to the data type of the at least one field. In some embodiments, the at least one data element may comprise a plurality of data elements, with each of the plurality of data elements having both an additional data type and an additional value assigned.

### TECHNICAL FIELD

Generally, the invention relates to databases, and, more particularly, to the storing and retrieval of information within a database.

### BACKGROUND

Databases, such as Structured Query Language (SQL) databases typically comprise a plurality of tables that each comprises a plurality of fields. The fields are generally assigned a particular data type which cannot be dynamically changed. Examples of these data types include, but are not limited to, “string”, “variant”, “integer”, “Boolean”, or other data types.

The requirement of having a particular data type assigned to a particular field creates a limitation as to the kinds of data that may be used within an existing database structure. This limitation of predefined data types inhibits the use of fields within the database from being dynamically adapted. In order to overcome this limitation, systems and methods that could allow for dynamic storage of a plurality of data types within a particular database field are needed.

### SUMMARY OF INVENTION

In one embodiment, a method is disclosed that can be used for storing information in a database that has at least one table. The at least one table has at least one field. The at least one field has a data type assigned to the at least one field. In some embodiments, at least one data element is stored in at least one field. The at least one data element may have a data type which is unrelated to the data type of the at least one field. In some embodiments, the at least one data element may comprise a plurality of data elements, with each of the plurality of data elements having both an additional data type and an additional value assigned.

In another embodiment, a system is disclosed that includes a database stored in a computer readable medium. The database comprises at least one table and one field, and the database comprises at least one data element. The at least one data element is unrelated to the at least one field and comprises at least one identification element.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts:

FIG. 1 is a block diagram of one system of storing additional data within a database system, according to one embodiment of the present disclosure;

FIG. 2 is another block diagram of one system of storing additional data within a database system, according to one embodiment of the present disclosure;

FIG. 3 is a method of storing additional data within a database system, according to one embodiment of the present disclosure;

FIG. 4 is a method of retrieving additional data within a database system, according to one embodiment of the present disclosure;

FIG. 5 is a block diagram of one embodiment of a system of using a plurality of clients to access additional information, according to one embodiment of the present disclosure;

FIG. 6 is a block diagram of another embodiment of a system of using a plurality of clients to access additional information, according to one embodiment of the present disclosure;

FIG. 7 is a block diagram of yet another embodiment of a system of using a plurality of clients to access additional information, according to one embodiment of the present disclosure; and

FIG. 8 is a computer system capable of being used by the embodiments disclosed herein.

### DETAILED DESCRIPTION

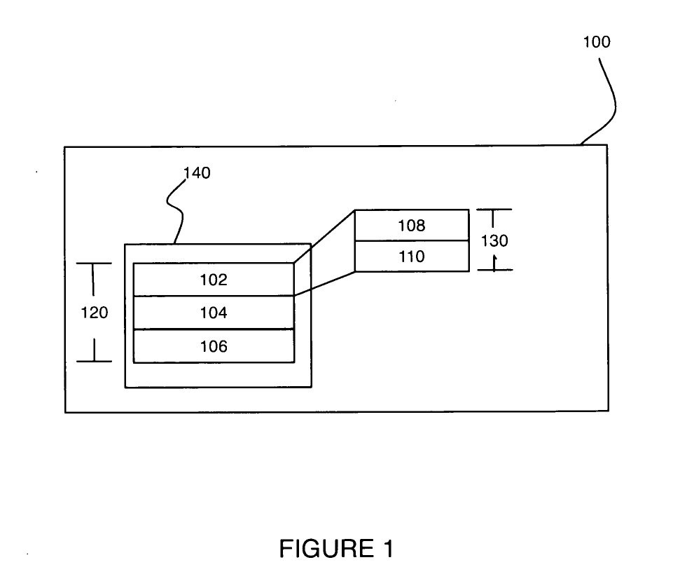

FIGS. 1 through 8, discussed below, and the various embodiments used to describe the principles of the present disclosure in this patent document, are by way of illustration only and should not be construed in any way to limit the scope of the disclosure. Systems and methods are disclosed herein that relate to the embedding and storing of data within a database. In one embodiment, a plurality of data types are embedded into data to be stored within a database. For sake of clarity, the phrase “additional data” will refer to some of the unique and novel uses of data within a database structure. These and other embodiments will be discussed below.

Databases systems can comprise a plurality of tables. Each of the table within a database can comprise a plurality of fields. These fields are generally identified with a particular data type (e.g., integer, string, double, etc.) Data that is stored in a particular field must correspond to the data type that the field is assigned. However, this configuration has a number of problems. For instance, data that does not necessarily correspond to a particular field within a table cannot be stored in the field. Also, the tables and the fields must be defined and created prior to usage. In many applications, it would be preferable to have dynamically configurable tables. Systems and methods that could overcome these limitations are needed.

The presently disclosed systems and methods allow information to be stored within a database system in a dynamic nature without the need to predefine all data types and fields. In some embodiments, this is done by defining a specific field as an “additional data” field. This field may be further assigned a type, such as a “text” type. Within this field specially formatted data, such as data formatted in an extended markup language (XML), may be stored. By formatting the data stored within the “additional data” field as XML, attributes may be assigned to the data within the field so as to allow any kind of data to be stored and retrieved. In order to retrieve this data, an XML parser may be used to interpret the data stored in the data field.

Throughout the present disclosure, data will be referred to as being stored in XML files. However, it is expressly contemplated that data may be stored in any kind of file and in any kind of format. The present disclosure should therefore not be read or interpreted to be limited to XML data.

FIG. 1 is a block diagram of a database 100 which comprises a table 140. Within table 140 there is a group of fields, including fields 102, 104, and 106. Each of these fields may be stored in the database 100 table 140 as database fields with preassigned data types. For the purposes of illustration, it may be assumed that in one embodiment, the field 102 is a text or string field, the field 104 is an integer field, and the field 106 is a float field. Also for the purposes of illustration, the field 102 will be used to store additional data through the unique and innovative systems and methods disclosed herein.

FIG. 1 also illustrates an additional group of fields 130 comprising fields 108 and 110 that are stored in field 120. The additional group of fields 130 may also be referred to as the “additional data” in one embodiment.

The data stored within the field 102 may for example take the form of a text string. The following is an example of such a text string:

```
<THINGS>
    <HEADER>Name</HEADER>
    <HEADER>Group</HEADER>
    <HEADER>Grade</HEADER>
    <HEADER>Name_Type</HEADER>
    <HEADER>Group_Type</HEADER>
    <HEADER>Grade_Type</HEADER>
    <THING type=“student”>
        <NAME>Jamie Jones</NAME>
        <NAME_TYPE>String</NAME_TYPE>
        <GROUP>3rd Grade</GROUP>
        <GROUP_TYPE>String</GROUP_TYPE>
        <GRADE>3</GRADE>
        <GRADE_TYPE>Integer</GRADE_TYPE>
    </THING>
    <THING type=“teacher”>
        <NAME>Julie Jackson</NAME>
        <NAME_TYPE>String</NAME_TYPE>
        <GROUP>Elementary Teacher</GROUP>
        <GROUP_TYPE>String</GROUP_TYPE>
        <GRADE>3</GRADE>
        <GRADE_TYPE>Integer</GRADE_TYPE>
    </THING>
</THINGS>
```

As can be seen, this text string comprises both the names of types of records, the elements within the records, and sufficient information to identify the data type of each record. The use of data in this way allows data to be stored within a database field without designating specific data types. Also formatting the data as XML prior to storing data allows for multiple types of data types to be stored within the same data field.

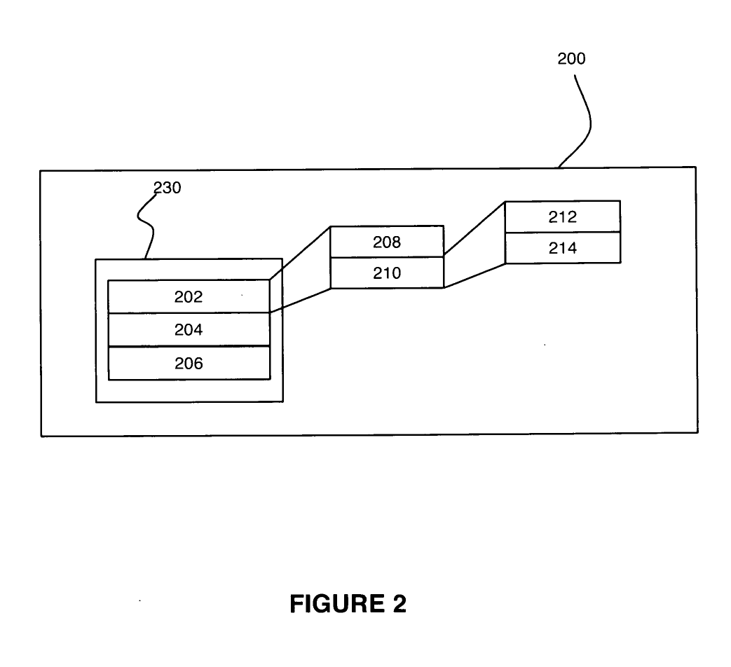

FIG. 2 is an illustration of the use of nested fields within additional data. It is understood that in the example shown in FIG. 1, there were two fields of additional data stored in the field 102. In the Example shown in FIG. 2, field corresponds to field 102, field 204 corresponds to field 104, and field 206 corresponds to field 106. Also shown in FIG. 2, fields 208 and 210 are stored in field 202. Fields 212 and 214 are stored as additional data within field 220. An example of how this data may be encoded in field 202 is shown below:

```
<THINGS> // data stored in field 208
    <HEADER>Name</HEADER>
    <HEADER>Name_Type</HEADER>
    <THING type=“student”>
        <NAME>Jamie Jones</NAME>
        <NAME_TYPE>String</NAME_TYPE>
    </THING>
</THINGS>
<THINGS2> //Data stored in field 210
    <HEADER>Name</HEADER>
    <HEADER>Name_Type</HEADER>
    <THING type=“Class Designation”>
        <NAME>Third Grade Class</NAME>
        <NAME_TYPE>String</NAME_TYPE>
    </THING>
</THINGS2>
<THINGS2A> //Data stored in field 212
    <HEADER>Name</HEADER>
    <HEADER>Name_Type</HEADER>
    <THING type=“Teacher”>
        <NAME>Jackie Slew</NAME>
        <NAME_TYPE>String</NAME_TYPE>
    </THING>
</THINGS2A>
<THINGS2B> //Data stored in field 214
    <HEADER>Cost</HEADER>
    <HEADER>Cost_Type</HEADER>
    <THING type=“Cost”>
        <NAME>1100</NAME>
        <NAME_TYPE>Integer</NAME_TYPE>
    </THING>
<THINGS2A>
```

The code to the comments where the XML tags are interpreted may be preassigned to allow any parser to obtain data from the tags.

Nesting data within the additional fields may be used when more complex data relationships are needed to be illustrated, offering the ability to create a multiple dimension data relationship between a plurality of data types. This extended data relationship may be used to represent relationships between data. For instance, groups from largest to smallest may be represented within each other.

One example of the representation of relationships between data may be where a first field comprises additional data with two fields. One field may comprise information related to a first group of students, and a second field may comprise information related to a second group of students. The first field may comprise an additional cost field indicating the total cost of a given item for the first group of students. Even without an explicit declaration, because of the location of the cost field and association may be assumed between the first group of students and the cost field.

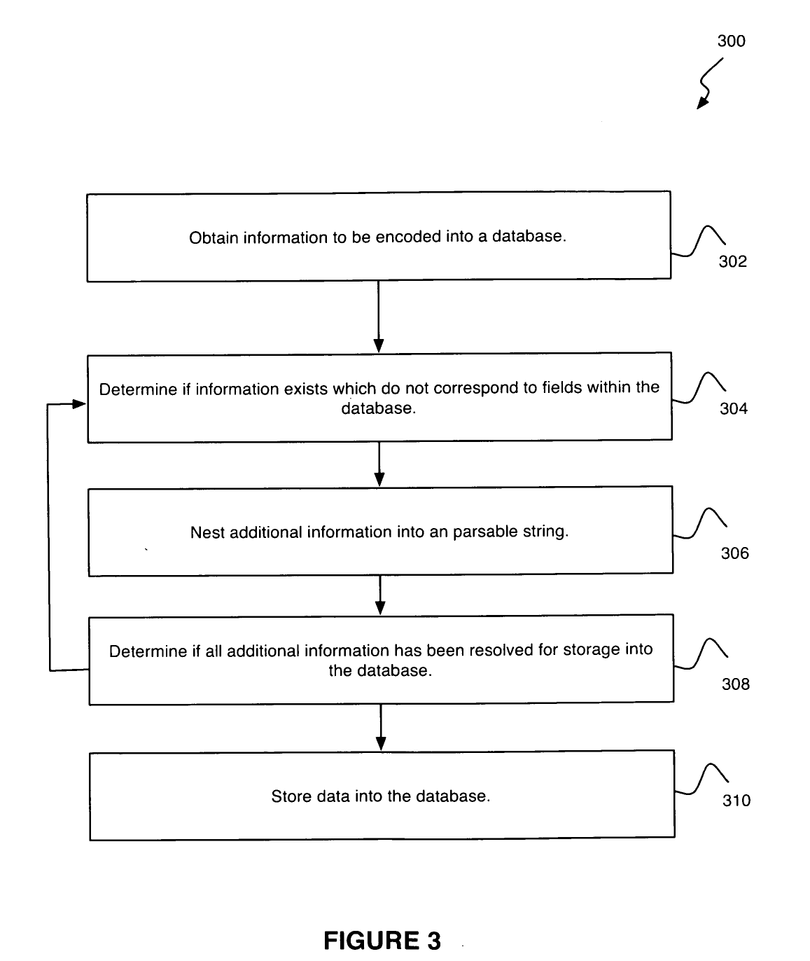

FIG. 3 is an example of one method of storing additional data into a database. In block 302, information is obtained will be included in the database. In block 304, there is a determination as to whether or the obtained information corresponds to fields within the database. In block 306, any information that does not correspond to fields within the database is nested into a parsable string. One example of this nesting is where existing data is formatted in XML. In block 308, there is a determination at all information is storable within the database. If all data now corresponds to fields within the databases the data is stored in the database in block 310. If there is data that does not correspond to a particular field, the data will be returned to block 304.

It is understood that in FIG. 3 a translating element may be needed. This translating element may be any system of method capable of transcoding existing data into a format which may stored as a data element within a database. While the previous examples have focused on the use of a text encoder, it is explicitly understood that a binary transcoder could be used allowing for data to be stored in binary format within the target database. The examples of binary data and text data are exemplary only, as any data types may be used.

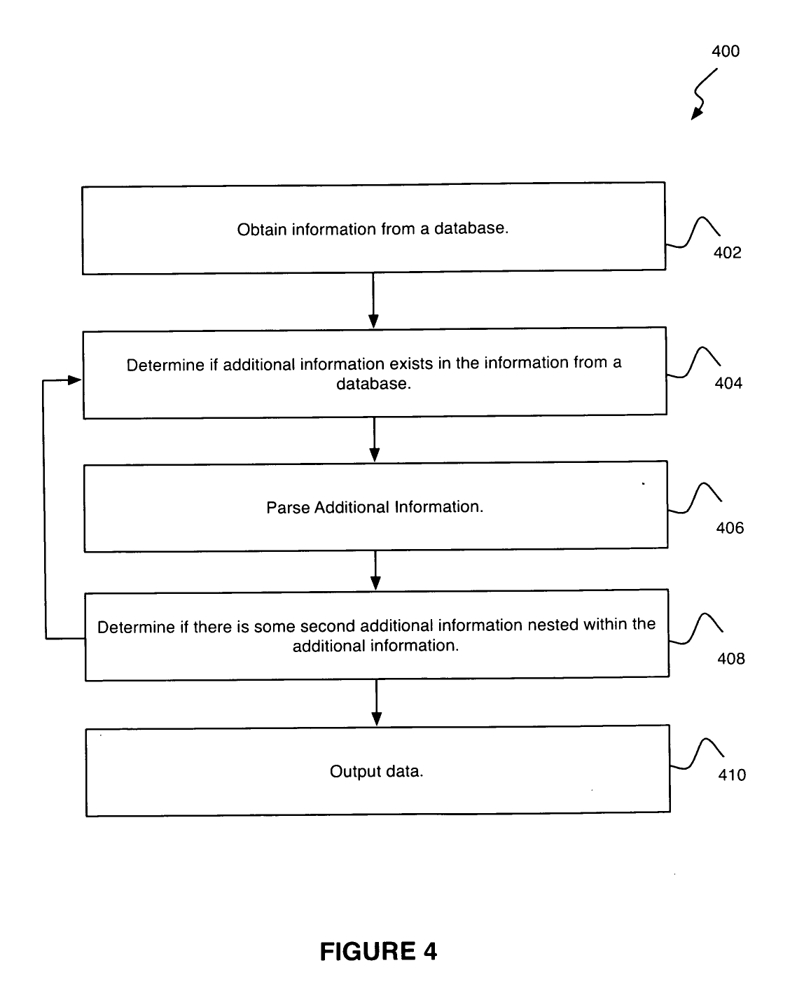

FIG. 4 is an example of the extraction of additional information from a database. First information is obtained from a database in block 402. There is then a determination if additional information exists within the obtained information in block 404. The following pseudo code might be used to determine if such additional information is present:

```
    // test for parsed data
if Parsetest (obtained text) <> nil then
    // conduct actual parsing
parsed text = parse (obtained text)
    return parsed text
else
    return obtained text
end if
```

If the parsing succeeds then additional information is parsed in block 406. In block 408, there is a determination as to whether there is additional information nested within the parsed text. This may be done using the same pseudo code as described above. If there is additional information, then the parsing as described in block 404 is preformed again. If there is not additional text, then there is an output of the information in block 410.

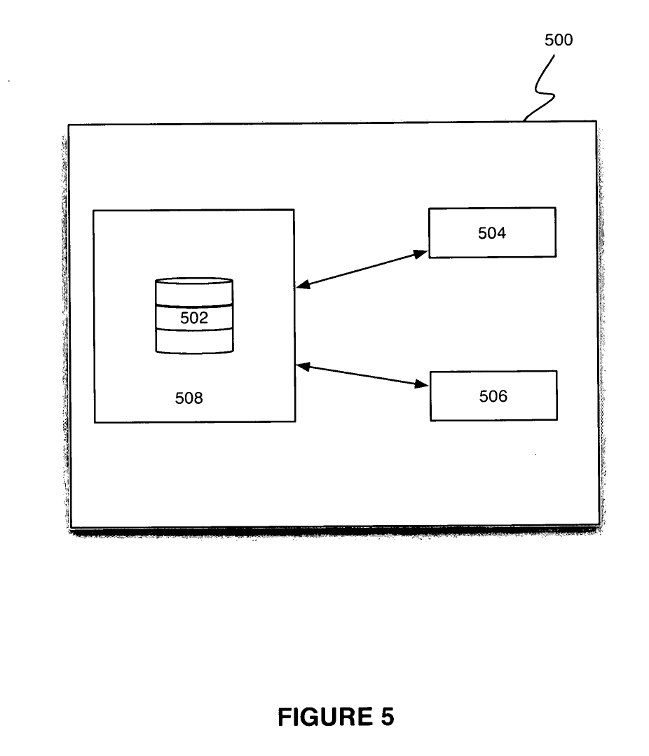

FIG. 5 is an example of a system which uses additional data stored within the database system 500. In this example, clients 504 and 506 are in communication with data base server 508. Database server comprises a database system 502. Clients 504 and 506 are able to use the disclosed systems and methods to access the additional information within the database 502. It is understood that both clients 504 and 506 may require additional parsing logic to read and write data within the database server 508. This additional logic may comprise information relating to the specific format that data is stored within the database server 508. FIG. 5 illustrates that a plurality of clients may access the data as disclosed in the present systems and methods.

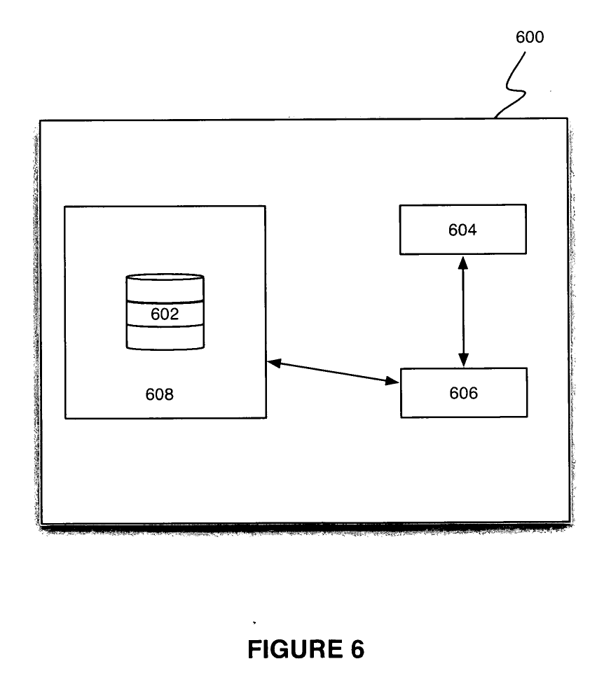

FIG. 6 is an example of alternative embodiment of the present system 600 illustrating clients 604 and 606, as well as server 608 comprising database server 602. In FIG. 5 each client contained the logic to parse data obtained from the database server. In FIG. 6, client 604 communicates through client 606. In this example, the parsing logic may be located in client 604 and client 606 may rely upon client 604 for access to server 608.

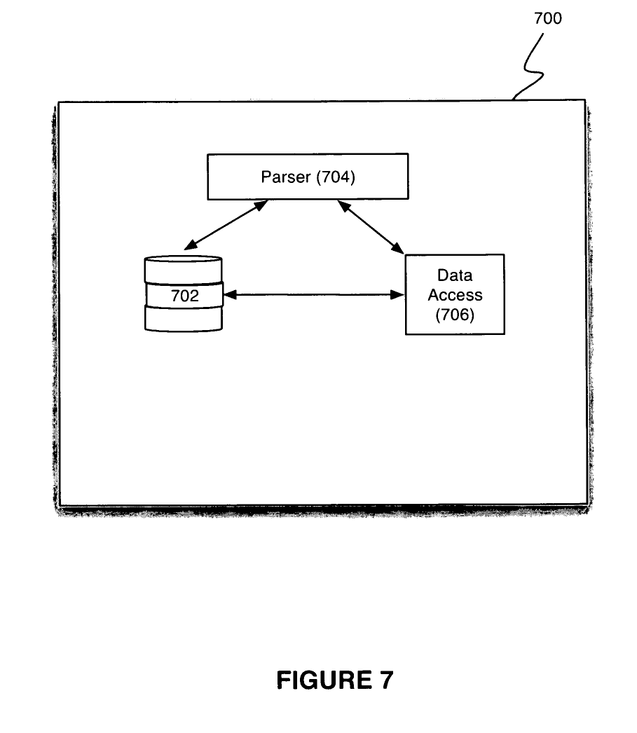

FIG. 7 a block diagram of the parsing database system in an alternative embodiment. As shown by system 700, there is a database 702 connected to both a parser 704 and a data access node 706. It is understood that the data access node 706 may be a client or any point of entry for data. In the example shown in FIG. 7, it is optional for the data access node 706 to use the parser 704. In some embodiments, it may be preferred to access the database directly, and in other embodiments IE may be preferable to obtain extended information through the database 702. The embodiment shown in FIG. 7 allows for the flexibility to only use the disclosed parsing methods when needed.

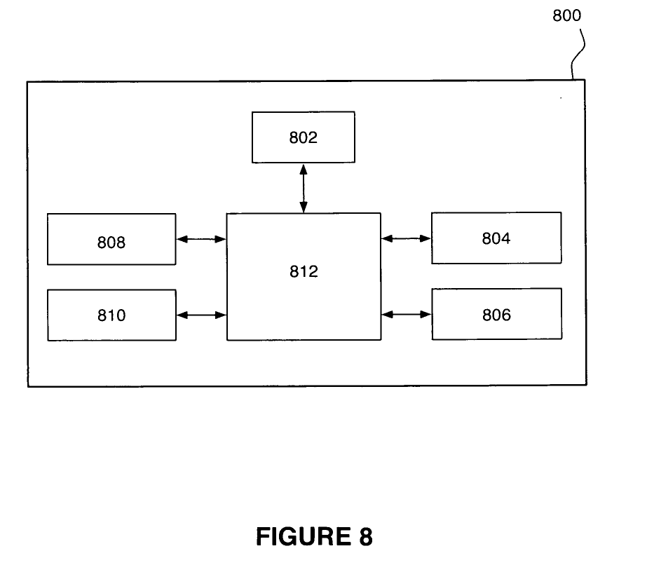

The disclosed clients and servers may be implemented on any system 800 with sufficient processing power, memory resources, and network throughput capability to handle the necessary workload placed upon it. FIG. 8 illustrates a system suitable for implementing one or more embodiments disclosed herein. The system 800 includes a processor 812 (which may be referred to as a central processor unit or CPU) that is in communication with memory devices including secondary storage 802, read only memory (ROM) 804, random access memory (RAM) 806, input/output (I/O) 808 devices, and network connectivity devices 810. The processor may be implemented as one or more CPUs.

The secondary storage 802 is typically comprised of one or more disk drives or tape drives and is used for non-volatile storage of data and as an over-flow data storage device if RAM 806 is not large enough to hold all working data. Secondary storage 802 may be used to store programs that are loaded into RAM 806 when such programs are selected for execution. The ROM 804 is used to store instructions and perhaps data that are read during program execution. ROM 804 is a non-volatile memory device that typically has a small memory capacity relative to the larger memory capacity of secondary storage. The RAM 806 is used to store volatile data and perhaps to store instructions. Access to both ROM 804 and RAM 806 is typically faster than to secondary storage 802.

I/O 808 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. The I/O devices may be configured to provide alerts, including audio and video alerts, when an interference device 106 is detected.

These network connectivity devices 810 may enable the processor 812 to communicate with a data network, or an Internet or one or more intranets. With such a network connection, it is contemplated that the processor 812 may receive information from the network, or may output information to the network in the course of performing the above-described method steps. Such information, which is often represented as a sequence of instructions to be executed using processor 812, may be received from and/or transmitted to the network 108, for example, in the form of a computer data signal embodied in a carrier wave.

Such information, which may include data or instructions to be executed using processor 812 for example, may be received from and outputted to the network, for example, in the form of a computer data baseband signal or signal embodied in a carrier wave. The baseband signal or signal embodied in the carrier wave generated by the network connectivity devices 810 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 812 executes instructions, codes, computer programs, scripts that it accesses from hard disk, floppy disk, optical disk (these various disk based systems may all be considered secondary storage 802), ROM 804, RAM 806, or the network connectivity devices 810. The processor 812 may also be used to determine that an interference device 106 is present.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

What is claimed is:

1. A method of storing data, comprising:
obtaining information to be stored in a database, wherein the database is stored in a computer readable medium, and wherein the database comprises at least one table and one field;
organizing at least one data element to be stored in at least one field, wherein the at least one data element is unrelated to the at least one field and comprises at least one identification element.

2. The method of claim 1, wherein the information is stored in a database system.

3. The method of claim 1, wherein a plurality of data elements are stored in the at least one field.

4. The method of claim 3, wherein the plurality of data elements are stored in an XML format.

5. The method of claim 4, wherein the XML format is used to determine the relationship of the plurality of data elements.

6. The method of claim 1, wherein the at least one data element comprises information related to the type of the at least one data element in addition to the at least one data element.

7. A system for data storage, comprising:
a database stored in a computer readable medium, wherein the database comprises at least one table and one field, and wherein the database comprises at least one data element, and wherein the at least one data element is unrelated to the at least one field and comprises at least one identification element.

8. The system of claim 7, further comprising a parser, wherein the parser is used to organize the data prior to the data being stored in the database.

9. The system of claim 7, wherein a plurality of data elements are stored in the data field.

10. The system of claim 7, wherein the computer readable medium is solid state disk drive.

11. The system of claim 7, wherein the database is a Structured Query Language (SQL) database.

12. The system of claim 7, wherein a processor is configured to organize the data being stored into the database into an XML format.

13. A method, comprising:
storing information in a database that has at least one table, wherein the at least one table has at least one field;
assigning the at least one field in the database a data type; and
storing at least one data element in the at least one field, wherein the at least data element comprises information which is not directed, wherein the at least one data element has a data type which is unrelated to the data type of the at least one field.

14. The method of claim 13, wherein the at least one data element comprises a plurality of data elements.

15. The method of claim 14, wherein each of the plurality of data elements has both an additional data type and an additional value assigned.

16. The method of claim 13, wherein the information is stored in a database system.

17. The method of claim 16, wherein the database system is an SQL database system.

18. The method of claim 14, wherein the plurality of data elements are stored in an XML format.

19. The method of claim 18, wherein relationships between the plurality of data elements are derived from the XML structure without explicit declarations.

20. The method of claim 18, wherein relationships between the plurality of data elements are derived from the XML structure with explicit declarations.
